(19) United States
(12) Patent Application Publication
(10) Pub. No.: US 2022/0180854 A1
(43) Pub. Date: Jun. 9, 2022

(54) SOUND EFFECTS BASED ON FOOTFALL

(71) Applicant: Sony Interactive Entertainment LLC, San Mateo, CA (US)

(72) Inventors: Derek Crosby, Lake Balboa, CA (US); Charles Ghislandi, Los Angeles, CA (US)

(21) Appl. No.: 17/535,628

(22) Filed: Nov. 25, 2021

Related U.S. Application Data
(60) Provisional application No. 63/118,900, filed on Nov. 28, 2020.

(51) Int. Cl. G10K 15/02; G11B 27/34

(52) U.S. Cl. CPC G10K 15/02; G11B 27/34

(57) ABSTRACT

Techniques are described for facilitating the coordination of audio video (AV) production using multiple actors in respective locations that are remote from each other, such that an integrated AV product can be generated by coordinating the activities of multiple remote actors in concert with one another. In an example, a machine learning module is used to generate sound effects (SFX) based on F-curves representing footfalls.

### FIELD

The application relates generally to technically inventive, non-routine solutions that are necessarily rooted in computer technology and that produce concrete technical improvements. In particular, the present application relates to techniques for enabling collaborative remote acting in multiple locations.

### BACKGROUND

Owing to health and cost concerns, people increasingly collaborate together from remote locations. As understood herein, collaborative movie and computer simulation (e.g., computer game) generation using remote actors can pose unique coordination problems because a director must direct multiple actors each potentially in his or her own studio or sound stage in making movies and for computer simulation-related activities such as motion capture (MoCap). For example, challenges exist in providing remote actors physical references on their individual stages in a manner that action is coordinated. Present principles provide techniques for addressing some of these coordination challenges.

### SUMMARY

Accordingly, an apparatus includes at least one processor programmed with instructions to receive at least a first F-curve representing a first audio, and based at least in part on the first F-curve, identify at least a first sound effect (SFX) to be associated with the first audio.

In example embodiments, the first audio may include a footfall, and the F-curve may include a representation over time of the footfall.

In some implementations the instructions can be executable to train a machine learning (ML) module using an input set of F-curves and ground truth SFX. The instructions may be further executable to identify the first SFX using the ML module. The first SFX can be associated with a first timestamp correlating the first SFX with a first location on the F-curve. In non-limiting examples the instructions can be executable to, based at least in part on the first F-curve, identify at least a second SFX to be associated with the first audio. The second SFX may be associated with a second timestamp correlating the second SFX with a second location on the F-curve. The first location can be associated with a heel rolling onto a sole and the second location can be associated with a sole rolling onto a toe.

In another aspect, a device includes at least one computer storage that is not a transitory signal and that in turn includes instructions executable by at least one processor to use at least one machine learning (ML) module to generate at least a first sound effect (SFX) based at least in part on a footfall representation. The instructions are executable to associate the first SFX with an audio representation.

In another aspect, a computer-implemented method includes receiving a representation of a footfall, providing the representation to at least one machine learning (ML) module, and responsive to the providing, receiving from the ML module at least a first sound effect (SFX). The method includes playing the first SFX with a visual representation of the footfall.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIGS. 2-4 illustrate a footfall;

FIG. 5 illustrates an F-curve generated by the footfall;

FIGS. 6 and 7 illustrate example logic in example flow chart format consistent with present principles; and

FIG. 8 illustrates a processor executing a machine learning algorithm consistent with present principles.

### DETAILED DESCRIPTION

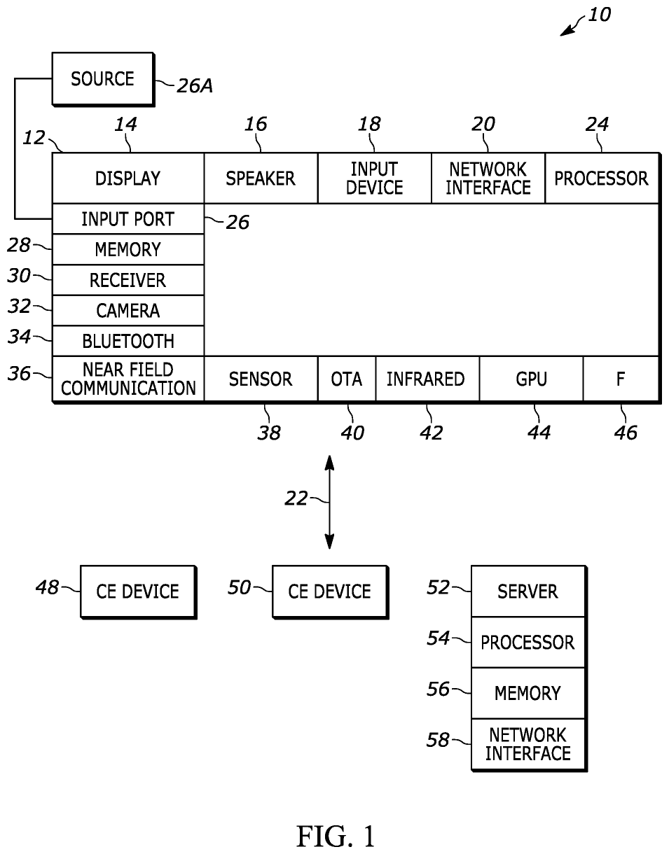

Now referring to FIG. 1, this disclosure relates generally to computer ecosystems including aspects of computer networks that may include consumer electronics (CE) devices. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security.

As used herein, instructions refer to computer-implemented steps for processing information in the system. Instructions can be implemented in software, firmware or hardware and include any type of programmed step undertaken by components of the system.

A processor may be a general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/ or made available in a shareable library. While flow chart format may be used, it is to be understood that software may be implemented as a state machine or other logical method.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

Now specifically referring to FIG. 1, an example system 10 is shown, which may include one or more of the example devices mentioned above and described further below in accordance with present principles. Note that computerized devices described in the figures herein may include some or all of the components set forth for various devices in FIG. 1.

The first of the example devices included in the system 10 is a consumer electronics (CE) device configured as an example primary display device, and in the embodiment shown is an audio video display device (AVDD) 12 such as but not limited to an Internet-enabled TV with a TV tuner (equivalently, set top box controlling a TV). The AVDD 12 may be an Android®-based system. The AVDD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVDD 12 and/or other computers described herein is configured to undertake present principles (e.g. communicate with other CE devices to undertake present principles, execute the logic described herein, and perform any other functions and/or operations described herein).

Accordingly, to undertake such principles the AVDD 12 can be established by some or all of the components shown in FIG. 1. For example, the AVDD 12 can include one or more displays 14 that may be implemented by a high definition or ultra-high definition “4K” or higher flat screen and that may or may not be touch-enabled for receiving user input signals via touches on the display. The AVDD 12 may also include one or more speakers 16 for outputting audio in accordance with present principles, and at least one additional input device 18 such as e.g. an audio receiver/microphone for e.g. entering audible commands to the AVDD 12 to control the AVDD 12. The example AVDD 12 may further include one or more network interfaces 20 for communication over at least one network 22 such as the Internet, other wide area network (WAN), a local area network (LAN), a personal area network (PAN), etc. under control of one or more processors 24. Thus, the interface 20 may be, without limitation, a Wi-Fi transceiver, which is an example of a wireless computer network interface, such as but not limited to a mesh network transceiver. The interface 20 may be, without limitation a Bluetooth transceiver, Zigbee transceiver, IrDA transceiver, Wireless USB transceiver, wired USB, wired LAN, Powerline or MoCA. It is to be understood that the processor 24 controls the AVDD 12 to undertake present principles, including the other elements of the AVDD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVDD 12 may also include one or more input ports 26 such as, e.g., a high definition multimedia interface (HDMI) port or a USB port to physically connect (e.g. using a wired connection) to another CE device and/or a headphone port to connect headphones to the AVDD 12 for presentation of audio from the AVDD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player.

The AVDD 12 may further include one or more computer memories 28 such as disk-based or solid-state storage that are not transitory signals, in some cases embodied in the chassis of the AVDD as standalone devices or as a personal video recording device (PVR) or video disk player either internal or external to the chassis of the AVDD for playing back AV programs or as removable memory media. Also, in some embodiments, the AVDD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVDD 12 is disposed in conjunction with the processor 24. However, it is to be understood that that another suitable position receiver other than a cellphone receiver, GPS receiver and/or altimeter may be used in accordance with present principles to e.g. determine the location of the AVDD 12 in e.g. all three dimensions.

Continuing the description of the AVDD 12, in some embodiments the AVDD 12 may include one or more cameras 32 that may be, e.g., a thermal imaging camera, a digital camera such as a webcam, and/or a camera integrated into the AVDD 12 and controllable by the processor 24 to gather pictures/images and/or video in accordance with present principles. Also included on the AVDD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVDD 12 may include one or more auxiliary sensors 38 (e.g., a motion sensor such as an accelerometer, gyroscope, cyclometer, or a magnetic sensor, an infrared (IR) sensor for receiving IR commands from a remote control, an optical sensor, a speed and/or cadence sensor, a gesture sensor (e.g. for sensing gesture command), etc.) providing input to the processor 24. The AVDD 12 may include an over-the-air TV broadcast port 40 for receiving OTA TV broadcasts providing input to the processor 24. In addition to the foregoing, it is noted that the AVDD 12 may also include an infrared (IR) transmitter and/or IR receiver and/or IR transceiver 42 such as an IR data association (IRDA) device. A battery (not shown) may be provided for powering the AVDD 12.

Still further, in some embodiments the AVDD 12 may include a graphics processing unit (GPU) 44 and/or a field-programmable gate array (FPGA) 46. The GPU and/or FPGA may be utilized by the AVDD 12 for, e.g., artificial intelligence processing such as training neural networks and performing the operations (e.g., inferences) of neural networks in accordance with present principles. However, note that the processor 24 may also be used for artificial intelligence processing such as where the processor 24 might be a central processing unit (CPU).

Still referring to FIG. 1, in addition to the AVDD 12, the system 10 may include one or more other computer device types that may include some or all of the components shown for the AVDD 12. In one example, a first device 48 and a second device 50 are shown and may include similar components as some or all of the components of the AVDD 12. Fewer or greater devices may be used than shown.

The system 10 also may include one or more servers 52. A server 52 may include at least one server processor 54, at least one computer memory 56 such as disk-based or solid state storage, and at least one network interface 58 that, under control of the server processor 54, allows for communication with the other devices of FIG. 1 over the network 22, and indeed may facilitate communication between servers, controllers, and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server and may include and perform “cloud” functions such that the devices of the system 10 may access a “cloud” environment via the server 52 in example embodiments. Or, the server 52 may be implemented by a game console or other computer in the same room as the other devices shown in FIG. 1 or nearby.

The devices described below may incorporate some or all of the elements described above.

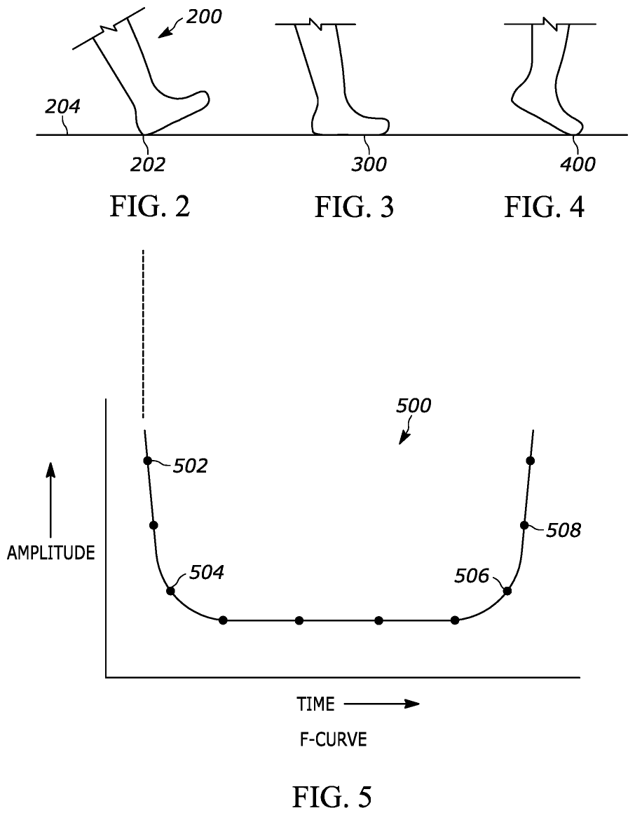

FIGS. 2-4 illustrate a computer-generated representation of a footfall of a character 200 or a video of a live character. Footfalls are detected for sound effects (SFX) to be triggered to avoid having to manually set a trigger to play a SFX. In FIG. 2, the heel 202 of a foot strikes the ground 204 at the beginning of a footfall, which can be represented as a graph 500 over time such as amplitude over time as shown in FIG. 5. The time the heel 202 strikes the ground is represented by a point 502 on the graph 500 in FIG. 5. The graph 500 may be an “F” curve of motion such as a splines such as a piecewise polynomial (parametric) curve.

FIG. 3 illustrates the continuing footfall in which contact with the ground has rolled from the heel 202 to the sole 300 of the foot. During the time the sole 300 is in contact with the ground the Y value of the graph 500 flat is flat as shown in FIG. 5 between points 504 and 506 representing the period from initial sole contact to the time when the sole rolls onto the toe 400 as shown in FIG. 4, beyond which, at point 508, the graph rises in the Y-axis. The graph 500 thus indicates graphically over time when the foot is coming down, planted, and coming up again.

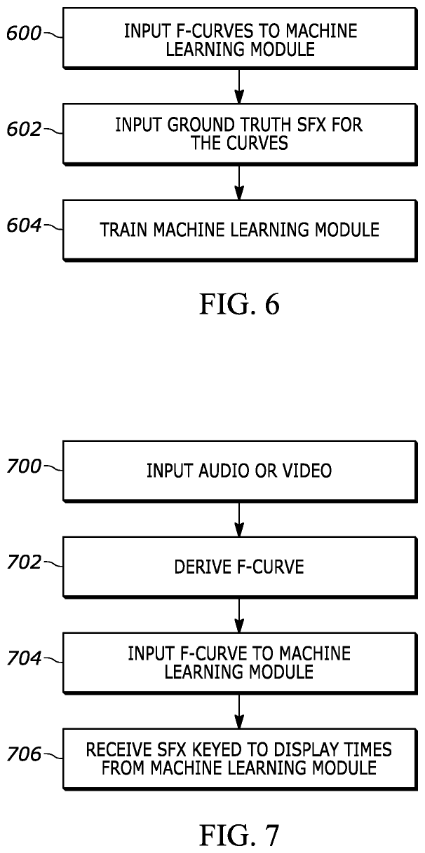

FIGS. 6 and 7 illustrate an example implementation of how to automatically set a flag for playing a SFX tied to the footfall using the graph 500. Commencing at block 600 in FIG. 6, training F-curves are input to a machine learning (ML) module that may include one or more neural networks, along with, at block 602, ground truth SFX tied to respective points on the F-curve by, e.g., timestamps. The ML module is trained on the training set of F-curves and accompanying ground truth SFX at block 604.

Once trained, the ML module may be employed as shown in FIG. 7. Commencing at block 700, audio and/or video of a footfall that may be computer-generated or that may be video of a real world footfall is input. An F-curve is derived at block 702 from the input at block 700 and sent to the ML module at block 704, which in response returns one or more SFX each keyed by a timestamp to a respective point on the F-curve (and, hence, to a respective time during the footfall) at block 706. The SFX subsequently may be played along with a visual representation of the footfall such as may be provided in a computer game or other animation or video. Thus, multiple SFX each associated with respective timestamps and, hence, respective times during the footfall may be provided, such that a first SFX may be correlated with, e.g., a heel rolling onto a sole and the second location can be associated with a sole rolling onto a toe.

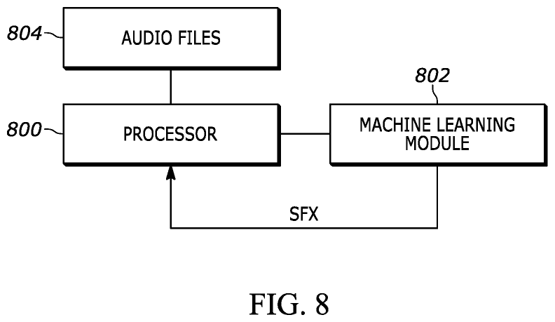

FIG. 8 illustrates a processor 800 accessing a ML module 802 consistent with principles herein to render output files 804 of SFX tied to respective footfall time points.

It will be appreciated that whilst present principals have been described with reference to some example embodiments, these are not intended to be limiting, and that various alternative arrangements may be used to implement the subject matter claimed herein.

What is claimed is:

1. An apparatus, comprising:
at least one processor programmed with instructions to:
receive at least a first F-curve representing a first audio; and
based at least in part on the first F-curve, identify at least a first sound effect (SFX) to be associated with the first audio.

2. The apparatus of claim 1, wherein the first audio comprises footfall.

3. The apparatus of claim 2, wherein the F-curve comprises a representation over time of the footfall.

4. The apparatus of claim 1, wherein the instructions are executable to train a machine learning (ML) module using an input set of F-curves and ground truth SFX.

5. The apparatus of claim 4, wherein the instructions are executable to identify the first SFX using the ML module.

6. The apparatus of claim 1, wherein the first SFX is associated with a first timestamp correlating the first SFX with a first location on the F-curve.

7. The apparatus of claim 6, wherein the instructions are executable to, based at least in part on the first F-curve, identify at least a second SFX to be associated with the first audio, the second SFX being associated with a second timestamp correlating the second SFX with a second location on the F-curve.

8. The apparatus of claim 7, wherein the first location is associated with a heel rolling onto a sole and the second location is associated with a sole rolling onto a toe.

9. A device comprising:
at least one computer storage that is not a transitory signal and that comprises instructions executable by at least one processor to:
use at least one machine learning (ML) module to generate at least a first sound effect (SFX) based at least in part on a footfall representation; and
associate the first SFX with an audio representation.

10. The device of claim 9, comprising the processor executing the instructions.

11. The device of claim 9, wherein the instructions are executable to:
transform an audio representation into an F-curve; and
use the ML module to generate the first SFX based at least in part on the F-curve.

12. The device of claim 11, wherein the F-curve comprises a representation over time of an amplitude of the footfall.

13. The device of claim 9, wherein the instructions are executable to train the ML module using an input set of F-curves and ground truth SFX.

14. The device of claim 11, wherein the first SFX is associated with a first timestamp correlating the first SFX with a first location on the F-curve.

15. The device of claim 14, wherein the instructions are executable to, based at least in part on the F-curve, identify at least a second SFX to be associated with the audio representation, the second SFX being associated with a second timestamp correlating the second SFX with a second location on the F-curve.

16. The device of claim 15, wherein the first location is associated with a heel rolling onto a sole and the second location is associated with a sole rolling onto a toe.

17. A computer-implemented method comprising:
receiving a representation of a footfall;
providing the representation to at least one machine learning (ML) module;
responsive to the providing, receiving from the ML module at least a first sound effect (SFX); and
playing the first SFX with a visual representation of the footfall.

18. The method of claim 17, wherein the representation comprises a representation over time of an amplitude of the footfall and the method comprises using the representation over time as input to the ML module to receive back the first SFX.

19. The method of claim 17, wherein the first SFX is associated with a first timestamp correlating the first SFX with a first time in audio.

20. The method of claim 19, comprising, based at least in part on audio, identifying least a second SFX associated with a second timestamp correlating the second SFX with a second time in the audio.
